(19) United States
(12) Patent Application Publication
(10) Pub. No.: US 2017/0150799 A9
(43) Pub. Date: Jun. 1, 2017

(54) HAIR COMB BODY INCLUDING MEASURING AND LEVELING FUNCTIONS

(71) Applicant: Ray Rita, Frankfort, IL (US)

(72) Inventor: Ray Rita, Frankfort, IL (US)

(21) Appl. No.: 14/728,550

(22) Filed: Jun. 2, 2015

Related U.S. Application Data
(60) Provisional application No. 62/007,654, filed on Jun. 4, 2014.

(51) Int. Cl. A45D 24/16; B26B 19/38; A45D 24/36

(52) U.S. Cl. CPC A45D 24/16; A45D 24/36; B26B 19/388

(57) ABSTRACT

A hair comb body physically associated with hair comb teeth having an electronic-based level that determines the angle of orientation of the associated hair comb teeth and a plurality of lights—visible from at least the front or back face of the body—that indicate the angle of orientation of the associated comb teeth as measured by the electronic-based level, wherein the electronic-based level can be selectively locked to a desired angle, such that the level selectively provides a human-perceivable indication (e.g. audible and/or visual) when the comb teeth are oriented at the desired angle, thus, simplifying the provision of a consistent haircut. A method of cutting hair using the hair comb body is also disclosed.

### BRIEF SUMMARY OF THE INVENTION

The present disclosure provides a comb particularly well adapted for use when cutting hair. In a preferred embodiment, the comb includes a removable, powered (e.g., battery powered, rechargeable or not), attachment that provides additional functionality to the comb. For example, the attachment may be a removable bar that provides functions such as:

(1) a level;

(2) a measurement tool;

(2) a display;

(3) a laser; and

(4) one or more function keys.

Portions of the functionality of the bar come from the interaction of the bar with a base station, as described further herein. The bar and base station may communicate with each other through transceivers or similar communication mechanisms. Further, the bar may be adapted to coordinate with a charging station. The charging station may be separate from or integrated within the base station.

The level may be a visual indicator that enables a user to determine with the comb is being held in a level position. The level may be displayed on the digital display or it may be an independent display. An advanced version may include a display of the relative angle of the comb compared to a reference position such that a user can accurately position the comb as desired. A preferred embodiment of the level is provided in the attached engineering documents.

The measurement tool may measure, calculate, or otherwise identify the length of hair through which the comb is run. An example of the measurement tool is described in the attached engineering documents. The example provided utilizes the interaction between the bar and the base station to track the distance the comb moves. For example, a user may initiate the measurement process through the function key(s). The base station then uses information captured from a pair of infra-red cameras to track the movement of the bar to determine the length of hair through which the comb is run. Alternate versions of the measurement tool are contemplated, including the direct measurement of the length of hair passing through the teeth of the comb.

The display may provide various information to the user, including the readings of the level and measurement tool, as well as additional settings and measurements. For example, functions of the bar may be dependent on whether the user is using the comb with the left or right hand and the display may show the current settings.

A laser element may be provided to project a laser generated line, for example, generate a straight line to use as a reference line when determining whether the length of the sideburns are even, whether the length of the cut is even, whether the bangs are cut straight (or cut too straight), etc.

The function key may be used to select amongst various functions and enter data to the device. For example, the function key may be used to trigger a measurement process, lock a desired angle, trigger the laser, etc.

In a preferred embodiment, the comb is approximately 7″×1.25″ and can use any of a varied number of tooth patterns. The bar may be removable from the comb so as to enable the comb to be separately disinfected and the bar to be separately cleaned, as needed.

The following engineering documents, code, drawings, etc., of the device further illustrate various embodiments of the invention. It is understood that various embodiments of the disclosed subject matter may be derived based on the disclosure provided herein.

1. A hair comb body physically associated with hair comb teeth, the hair comb body comprising:
a front face;
a back face;
an electronic-based level that determines the angle of orientation of the associated hair comb teeth; and
a plurality of lights visible from at least one of the front face and the back face of the hair comb body, wherein the plurality of lights together provide an indication of the angle of orientation of the associated hair comb teeth as measured by the electronic-based level, wherein the electronic-based level can be selectively locked to a desired angle, such that the electronic-based level selectively provides a human-perceivable indication when the hair comb teeth are oriented at the desired angle.

2. The hair comb body of claim 1 wherein the human-perceivable indication is audible, the hair comb body further comprising an audio speaker.

3. The hair comb body of claim 1 further comprising a switch that upon activation selectively locks the electronic-based level to the desired angle.

4. The hair comb body of claim 1 wherein the hair comb body can be adapted to accommodate any type of hair comb teeth.

5. The hair comb body of claim 1 further comprising:
a means for measuring a length of hair passing through the associated comb teeth; and
an electronic-based display for displaying the length of hair.

6. A method of cutting hair comprising:
bringing a hair comb body near hair, the hair comb body comprising an electronic-based level that determines the angle of orientation of associated hair comb teeth, wherein the electronic-based level can be selectively locked to a desired angle, such that the electronic-based level selectively provides a human-perceivable indication when the hair comb teeth are oriented at the desired angle;
adjusting the hair comb body to the desired angle;
locking the electronic-based level at the desired angle;
adjusting the hair comb body on the hair until the electronic-based level provides the human-perceivable indication; and
cutting the hair along the comb in accordance with the desired angle.

7. The method of claim 6 further comprising cutting the hair on the other side of the head by flipping the hair comb body over and adjusting until the electronic-based level provides the human-perceivable indication.

8. The method of claim 3 wherein the hair comb body further comprises a plurality of lights visible through at least one of the front face and the back face of the hair comb body, wherein the plurality of lights together provide an indication of the angle of orientation of the associated hair comb teeth as measured by the electronic-based level, the method further comprising:
providing a visual cue as to the angle of the associated hair comb teeth along the associated hair.
